(19) United States
(12) Patent Application Publication
(10) Pub. No.: US 2011/0037789 A1
(43) Pub. Date: Feb. 17, 2011

(54) BACKLIGHT DEVICE, DISPLAY DEVICE AND TELEVISION RECEIVER

(75) Inventor: Kohji Hisakawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/988,139

(22) PCT Filed: Apr. 20, 2009
(86) PCT No.: PCT/JP2009/057848

§ 371 Date: Oct. 15, 2010

(30) Foreign Application Priority Data
Apr. 24, 2008 (JP) 2008-113376

(51) Int. Cl. G09G 5/10; G02F 1/13357

(52) U.S. Cl. 345/690; 362/97.1

(57) ABSTRACT

Provided is a backlight device having improved heat dissipating performance. The backlight device (20) is provided with a fluorescent lamp (90), a reflection sheet (80), a backlight chassis (50), a power supply substrate (60) to be attached to a main body section (51) of the backlight chassis, a tuner substrate (61) and an inverter substrate (62). The power supply substrate, the tuner substrate and the inverter substrate are arranged between the reflection sheet and the main body section of the backlight chassis.

### TECHNICAL FIELD

The present invention relates to a backlight device, a display device, and a television receiver, and more specifically relates to a backlight device, a display device, and a television receiver that are provided with a reflection member and a circuit board.

### BACKGROUND ART

Conventionally, liquid crystal display devices provided with a reflection member and a circuit board have been known (for example, see Patent Literature 1). The just mentioned Patent Literature 1 discloses a liquid crystal display device provided with: a light source (fluorescent lamp); a light guide plate on which light emitted from the light source is incident; a reflection sheet (a reflection member) that is placed at a back surface side of the light guide plate and has a function of reflecting light; a bottom plate (chassis) including a bottom portion (back surface portion) placed at a back surface side of the reflection sheet; a circuit board attached to a back surface side of the bottom portion of the bottom plate; and a cover that covers the back surface side of the circuit board and the bottom plate.

According to the above-described Patent Document 1, the reflection sheet is placed on a front surface of the bottom portion of the bottom plate, and the circuit board is attached to the back surface side of the bottom portion of the bottom plate.

### CITATION LIST

### Patent Literature

Patent Literature 1: JP-A-2007-264369

### SUMMARY OF THE INVENTION

### Technical Problem

However, with the structure of the above-described Patent Document 1, in which the reflection sheet (reflection member) is placed above the front surface of the bottom portion (back surface portion) of the bottom plate (chassis), a space between the reflection sheet and the bottom portion of the bottom plate is so small that air convection does not easily occur in an air layer between the reflection sheet and the bottom portion of the bottom plate. Thus, when the reflection sheet is heated to a high temperature by heat from the light source (fluorescent lamp), the heat of the reflection sheet cannot be easily transferred to the bottom plate, and this is inconvenient. As a result, it is disadvantageously difficult to improve heat dissipating performance.

Incidentally, with a structure like the structure of Patent Literature 1, in which the circuit board is attached to the back surface side of the bottom portion of the bottom plate, replacement of the circuit board needs to be carried out from a back surface side of the liquid crystal display device by detaching the cover from the bottom plate. Liquid crystal display devices are often set with their back surface sides located close to a wall, for example, and in such a case, they need to be moved to replace a circuit board. In particular, with a large liquid crystal display device, just moving the liquid crystal display device is sometimes difficult, which tends to degrade workability in replacement of the circuit board.

The present invention has been made to solve the above problems, and an object of the present invention is to provide a backlight device, a display device, and a television receiver capable of improving heat dissipating performance.

### Solution to Problem

To achieve the above object, according to a first aspect of the present invention, a backlight device is provided with: a fluorescent lamp; a reflection member that has a function of reflecting light from the fluorescent lamp; a chassis that includes a back surface portion placed at a back surface side of the reflection member; and a circuit board that is attached to the back surface portion of the chassis. Here, the circuit board is placed between the reflection member and the back surface portion of the chassis.

With the backlight device according to the first aspect, by placing the circuit board, as described above, between the reflection member and the back surface portion of the chassis, it is possible to increase a distance between the reflection member and the back surface portion of the chassis compared with, for example, in a case where the reflection member is placed in contact with a surface of the back surface portion of the chassis. Thus, a larger space can be formed between the reflection member and the back surface portion of the chassis, and this makes it easier for air convection to occur in an air layer between the reflection member and the back surface portion of the chassis. As a result, when the reflection member is heated to a high temperature by heat from the fluorescent lamp, the heat of the reflection member can be easily transferred to the chassis, which leads to improved heat dissipating performance.

Furthermore, with the backlight device according to the first aspect, by placing the circuit board between the reflection member and the back surface portion of the chassis as described above, replacement of the circuit board can be carried out from a front side of a display device (backlight device). Thus, even in a case where a display device (backlight device) is set close to, or recessed in, a wall or the like, the circuit board can be replaced without moving the display device (backlight device). Accordingly, it is particularly effective to apply the present invention to a wall-hung television receiver, a recessed television receiver that is recessed in a wall or the like, a large-size television receiver that is too large to be easily moved, and the like.

Moreover, with the backlight device according to the first aspect, by placing the circuit board between the reflection member and the back surface portion of the chassis as described above, it is possible to place the circuit board at an inner side (front side) of the chassis. Thus, in a case where the backlight device of the present invention is used in a television receiver having no cabinet provided at a back surface side of the chassis, it is possible to prevent the circuit board from being exposed, and as a result, adhesion of dust, water, and the like onto the circuit board is prevented. Accordingly, it is particularly effective to apply the present invention to a television receiver having no cabinet provided at the back surface side of the chassis.

In the backlight device according to the first aspect described above, it is preferable that at least part of the circuit board be placed a predetermined distance away from the back surface portion of the chassis. This structure allows a still larger space to be formed between the reflection member and the back surface portion of the chassis, and this makes it still easier for air convection to occur in the air layer between the reflection member and the back surface portion of the chassis. Thus, when the reflection member is heated to a high temperature by heat from the fluorescent lamp, the heat of the reflection member can be transferred to the chassis more easily, which leads to further improved heat dissipating performance.

In the backlight device according to the first aspect described above, it is preferable that at least part of the reflection member be placed a predetermined distance away from the circuit board. This structure allows a still larger space to be formed between the reflection member and the back surface portion of the chassis, and this makes it still easier for air convection to occur in the air layer between the reflection member and the back surface portion of the chassis. Thus, when the reflection member is heated to a high temperature by heat from the fluorescent lamp, the heat of the reflection member can be transferred to the chassis more easily, which leads to further improved heat dissipating performance.

It is preferable that the backlight device according to the first aspect described above be further provided with a support member that is placed at a front side of the back surface portion of the chassis to support the reflection member. This structure makes it easy to hold the reflection member at a predetermined position.

In the above-described backlight device provided with the support member, it is preferable that the support member be structured to be attached to the chassis, and that the circuit board be detachable/attachable with respect to the back surface portion of the chassis with the support member attached to the chassis. With this structure, it is possible to replace the circuit board without detaching the support member from the chassis, and thus to improve workability in replacement of the circuit board.

In the above-described backlight device in which the support member is structured to be attached to the chassis, it is preferable that an opening portion that allows the circuit board to pass therethrough be formed in the support member. With this structure, even in a case, for example, in which the support member is placed all over the chassis, it is possible to replace the circuit board easily without detaching the support member from the chassis.

In the above-described backlight device in which the opening portion is formed in the support member, it is preferable that the support member include a support portion that is placed a predetermined distance away from the back surface portion of the chassis to support the reflection member, and that the support portion be lattice-shaped. By providing, in the support member, the support portion placed the predetermined distance away from the circuit board, the distance between the reflection member and the circuit board can be further increased easily. This makes it easier to form a still larger space between the reflection member and the back surface portion of the chassis, and this makes it easier for air convection to occur in the air layer between the reflection member and the back surface portion of the chassis. Furthermore, by forming the support portion to be lattice-shaped, it is easy to form, in the support member, the opening portion that allows the circuit board to pass therethrough.

It is preferable that the above-described backlight device provided with the support member further include: an optical sheet that is placed at a front side with respect to the fluorescent lamp; and a sheet support member that is placed at a rear side of the optical sheet to prevent the optical sheet from being warped. Here, the support member includes a support portion that is placed a predetermined distance away from the circuit board to support the reflection member, and the sheet support member is provided in the support portion of the support member. By thus providing, in the support member, the support portion placed the predetermined distance away from the circuit board, the distance between the reflection member and the circuit board can be further increased easily. This allows a still larger space to be formed between the reflection member and the back surface portion of the chassis, making it still easier for air convection to occur in the air layer between the reflection member and the back surface portion of the chassis. In addition, the provision of the sheet support member for preventing the optical sheet from being warped, in the support portion of the support member, makes it easier to detach the circuit board from the back surface portion of the chassis than in a case where the sheet support member is attached directly to the back surface portion of the chassis.

It is preferable that the above-described backlight device provided with the support member further include: a lamp holding member that holds the fluorescent lamp. Here, the support member includes a support portion that is placed a predetermined distance away from the circuit board and supports the reflection member, and the lamp holding member is provided in the support portion of the support member. By thus providing, in the support member, the support portion placed the predetermined distance away from the circuit board, the distance between the reflection member and the circuit board can be further increased easily. This allows a still larger space to be formed between the reflection member and the back surface portion of the chassis, and this makes it still easier for air convection to occur in the air layer between the reflection member and the back surface portion of the chassis. In addition, by providing the lamp holding member, which supports the fluorescent lamp, in the support portion of the support member, the circuit board can be detached from the back surface portion of the chassis more easily than in a case in which the lamp holding member is directly attached to the back surface portion of the chassis.

In the backlight device according to the first aspect described above, it is preferable that the circuit board be formed with a plurality of circuit boards, and that the circuit boards be connected to an adjacent circuit board of the circuit boards by electric wiring, and detachable/attachable with respect to the electric wiring. With this structure, it is possible to detach (replace) just one circuit board to replace the circuit board, for example, and this helps improve workability in replacement of the circuit board.

In the backlight device according to the first aspect described above, the circuit board may be structured to include at least one of an inverter board, a tuner board, and a power supply board.

According to a second aspect of the present invention, a display device is provided with: any one of the backlight devices described above; and a display panel illuminated by the backlight device. With this structure, a display device capable of improving heat dissipating performance can be obtained.

According to a third aspect of the present invention, a television receiver is provided with: the display device described above; a cabinet covering at least part of the display device; and a speaker. With this structure, it is possible to obtain a television receiver capable of improving heat dissipating performance.

In the television receiver according to the third aspect described above, it is preferable that the cabinet be not provided at a back surface side of the display device, and the cabinet be structured to cover at least part of a front surface side of the display device. Thus, in a case as well where the backlight device of the present invention is applied to a television receiver that is not provided with a cabinet at a back surface side of the chassis, it is possible to prevent the circuit board from being exposed to the outside, and as a result, adhesion of dust, water, and the like onto the circuit board is prevented. Accordingly, it is particularly effective to apply the present invention to a television receiver having no cabinet provided at the back surface side of the chassis.

### Advantageous Effects of the Invention

As discussed above, according to the present invention, it is possible to easily obtain a backlight device, a display device, and a television receiver that are capable of improving heat dissipating performance.

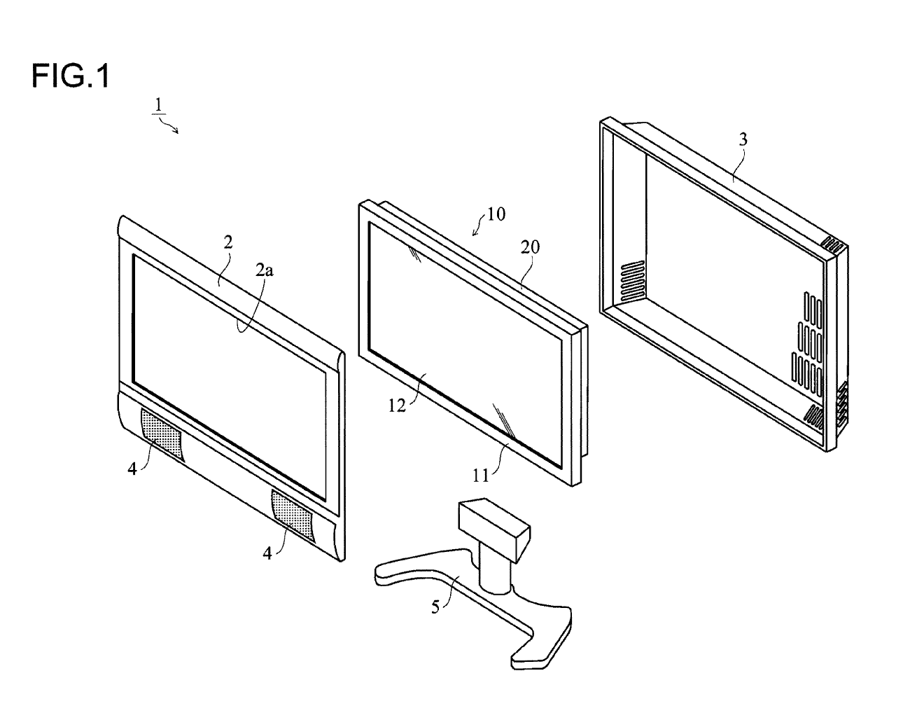

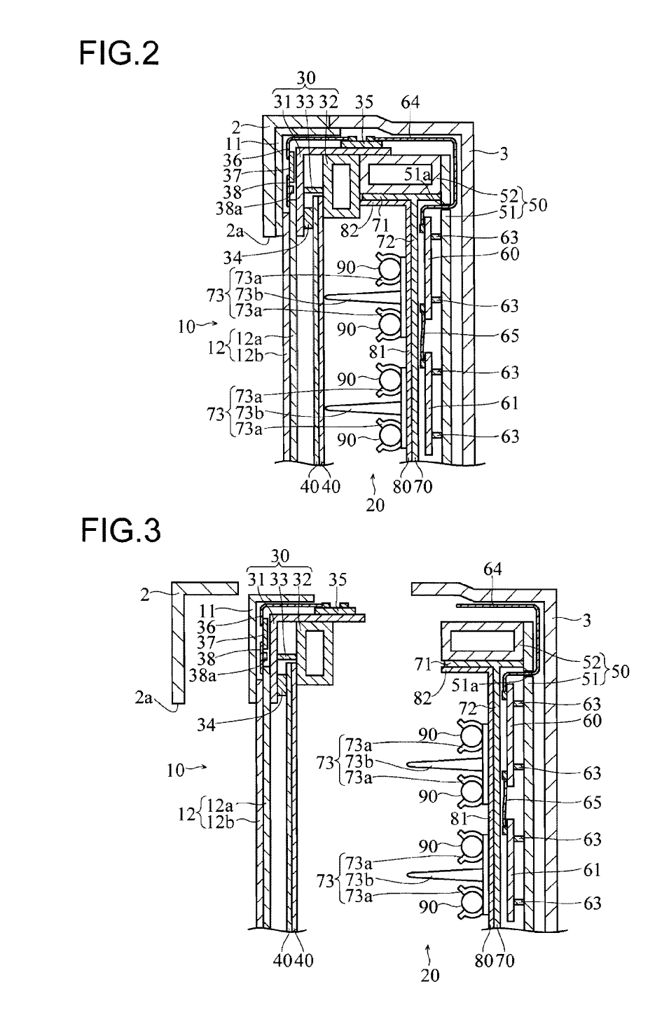

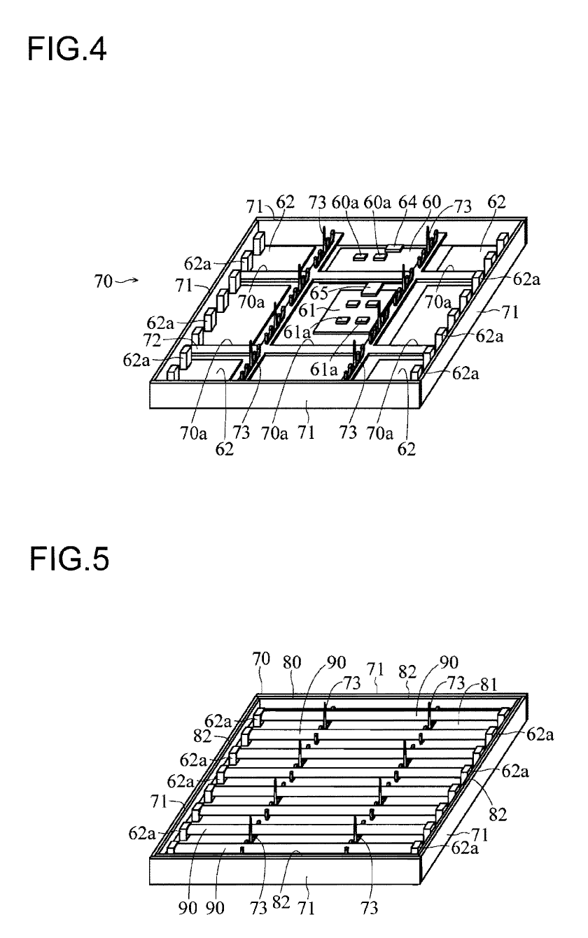

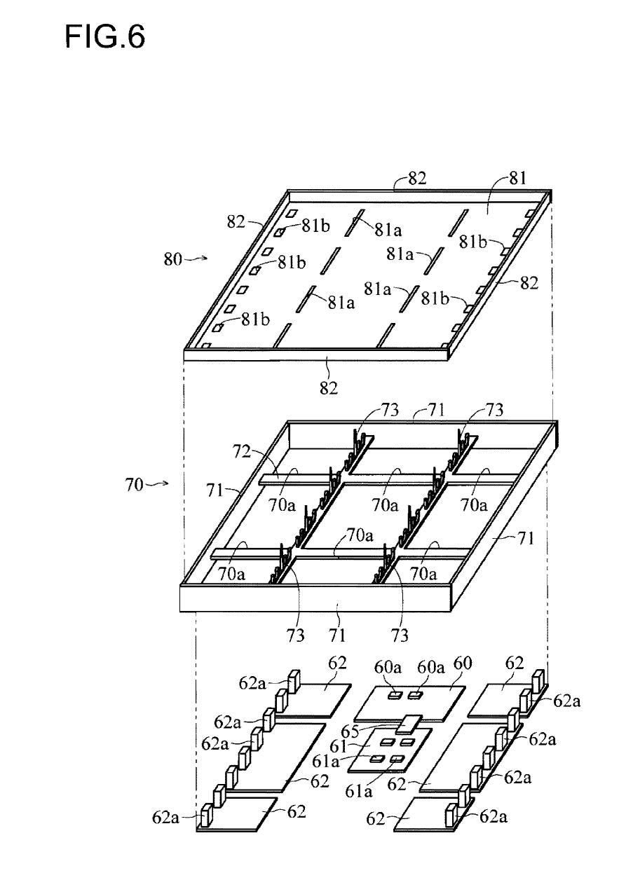

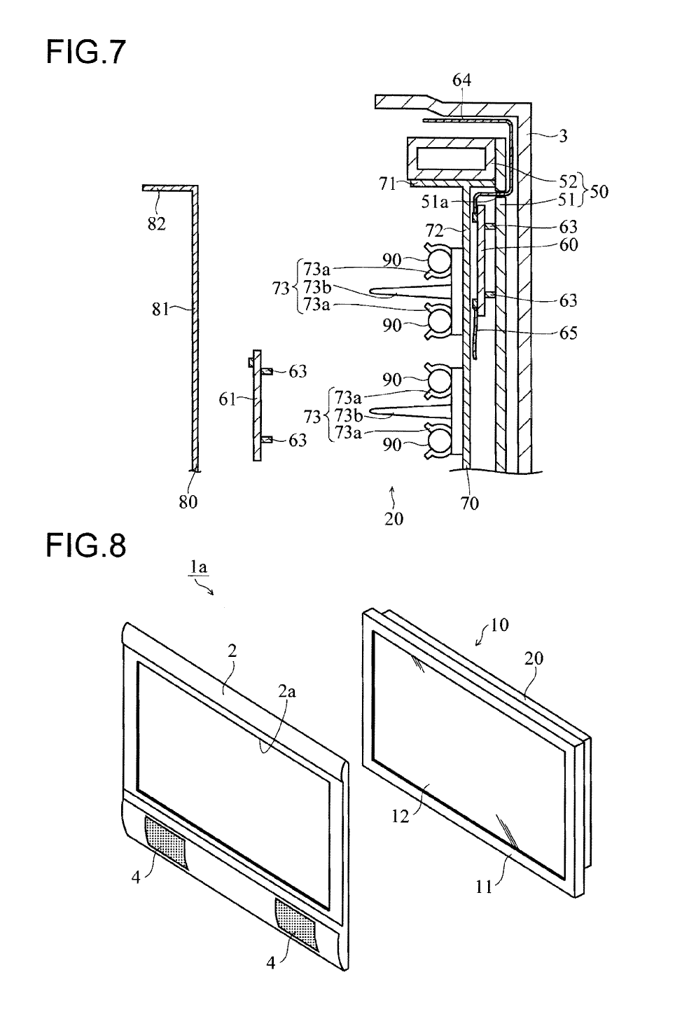

### BRIEF DESCRIPTION OF DRAWINGS

[FIG. 1] is an exploded perspective view showing the entire structure of a liquid crystal television receiver provided with a backlight device according to an embodiment of the present invention;

[FIG. 2] is a sectional view showing the construction of the liquid crystal television receiver provided with the backlight device according to the embodiment shown in FIG. 1;

[FIG. 3] is a sectional view showing the construction of the liquid crystal television receiver provided with the backlight device according to the embodiment shown in FIG. 1;

[FIG. 4] is a perspective view for illustrating the construction of the backlight device according to the embodiment shown in FIG. 2;

[FIG. 5] is a perspective view for illustrating the construction of the backlight device according to the embodiment shown in FIG. 2;

[FIG. 6] is an exploded perspective view for illustrating the construction of the backlight device according to the embodiment shown in FIG. 2;

[FIG. 7] is a sectional view for illustrating a method of replacing a power supply board, a tuner board, and an inverter board of the backlight device according to the embodiment shown in FIG. 2; and

[FIG. 8] is an exploded perspective view showing the entire structure of a liquid crystal television receiver according to a modified example of the present invention.

### MODE FOR CARRYING OUT THE INVENTION

With reference to FIGS. 1 to 6, a description will be given of a liquid crystal television receiver 1 provided with a backlight device 20 according to an embodiment of the present invention. The liquid crystal television receiver 1 is an example of the “television receiver” of the present invention.

As shown in FIG. 1, the liquid crystal television receiver 1 having the backlight device 20 according to the embodiment of the present invention is provided with: a liquid crystal display device 10 including the backlight device 20; a front cabinet 2 and a rear cabinet 3 in which the liquid crystal display device 10 is housed; a speaker 4 attached to the front cabinet 2; and a stand 5. The front cabinet 2, the rear cabinet 3, the speaker 4, and the stand 5 may be conventional ones that have been commonly used, and hence they will each be described briefly. The liquid crystal display device 10 is an example of the “display device” of the present invention, and the front and rear cabinets 2 and 3 are an example of the “cabinet” of the present invention.

The front cabinet 2 is provided such that it covers a front surface side of the liquid crystal display device 10, and the front cabinet 2 has a window portion 2a formed at a portion thereof corresponding to a liquid crystal display panel 12 of the liquid crystal display device 10, which will be described later. The rear cabinet 3 is provided such that it covers the entirety of a back surface side (rear side) of the liquid crystal display device 10. The liquid crystal display device 10 is housed in the front and rear cabinets 2 and 3. The speaker 4 has a function of emitting audio based on an audio signal generated by a tuner board 61 (circuit component 61a), which will be described later. The liquid crystal display device 10 is supported by the stand 5. The structure may be such that the speaker 4 is fitted to the liquid crystal display device 10.

As shown in FIG. 2, the liquid crystal display device 10 is formed with a bezel 11, which is placed inside the front cabinet 2, a liquid crystal display panel 12, whose edge portion is covered with the bezel 11, and the backlight device 20, which is placed on a back surface side of the liquid crystal display panel 12. The liquid crystal display panel 12 is an example of the “display panel” of the present invention.

The liquid crystal display panel 12 includes an AM substrate (active matrix substrate) 12a and a counter substrate 12b placed to face the AM substrate 12a. Liquid crystal (not shown) is sealed between the AM substrate 12a and the counter substrate 12b. The liquid crystal display panel 12 functions as a display panel by being illuminated by the backlight device 20.

The backlight device 20 is a direct-type backlight device. As shown in FIGS. 2 and 3, the backlight device 20 is formed with a metal frame 30, a plurality of optical sheets 40, a metal backlight chassis 50, a power supply board 60, a tuner board 61, and inverter boards 62 (see FIG. 4), a resin support member 70, a reflection sheet 80, and a plurality of fluorescent lamps 90. The backlight chassis 50 is an example of the “chassis” of the present invention, and the power supply board 60, the tuner board 61, and the inverter board 62 are examples of the “circuit board” of the present invention. The reflection sheet 80 is an example of the “reflection member” of the present invention.

The frame 30 is placed at a back surface side (rear side) of the bezel 11. The frame 30 includes a main body portion 31 having an L-shaped section, a square pipe portion 32 fixed to the main body portion 31, and a spacer 33 placed between the main body portion 31 and the square pipe portion 32.

An elastic member 34 is fixed to the main body portion 31. The elastic member 34, together with the square pipe portion 32, sandwichingly holds the plurality of optical sheets 40. The plurality of optical sheets 40 include a prism sheet, a lens sheet, etc., and have a function of collecting light from the fluorescent lamps 90 within a predetermined viewing angle.

The square pipe portion 32 has a function as a reinforcing member, and prevents the main body portion 31 (the frame 30) from being warped or bent. A distance between the square pipe portion 32 and the main body portion 31 is kept constant by the spacer 33 placed between the square pipe portion 32 and the main body portion 31.

To the main body portion 31, a connection board 35 is fixed. To one side (front side) of the connection board 35, a source board 37 is connected via an FPC (flexible printed circuits) 36. To the source board 37, an FPC 38 to which a source driver 38a is attached is connected. The FPC 38 is connected to the AM substrate 12a. The other side (rear side) of the connection board 35 is structured to be detachable/attachable with respect to an FPC 64, which will be described later.

A backlight chassis 50 includes a main body portion 51, which is plate-shaped, and a square pipe portion 52, which is fixed to a circumference portion of the main body portion 51. The square pipe portion 52 has a function as a reinforcing member, and prevents the main body portion 51 (the backlight chassis 50) from being warped or bent. Incidentally, instead of fixing the square pipe portion 52 to the main body portion 51, a structure may be adopted such that the main body portion 51 (the backlight chassis 50) is reinforced by bending the circumference portion thereof. The main body portion 51 is an example of the “back surface portion” of the present invention.

Here, according to the present embodiment, as shown in FIGS. 2 and 4, at a front side of the main body portion 51 (the backlight chassis 50), the power supply board 60, the tuner board 61, and the inverter board 62 (see FIG. 4) are placed.

As shown in FIG. 4, to the power supply board 60, a plurality of circuit components 60a are attached, and to the tuner board 61 as well, a plurality of circuit components 61a are attached. The power supply board 60 (the circuit components 60a) is structured to supply power to the speaker 4, the tuner board 61, the fluorescent lamps 90, etc. The tuner board 61 (the circuit components 61a) has a function of generating an image signal and an audio signal of a predetermined channel from a radio wave it receives. To the inverter board 62 are fixed lamp sockets 62a, to which both ends of the fluorescent lamps 90 (see FIG. 5) are attached, and the inverter board 62 has a function of making the fluorescent lamps 90 emit light.

According to the present embodiment, as shown in FIG. 2, the power supply board 60 and the tuner board 61 are fixed to the main body portion 51 of the backlight chassis 50 via a plurality of spacers 63. Likewise, the inverter board 62 (see FIG. 4) is also fixed to the main body portion 51 of the backlight chassis 50 via a plurality of spacers (not shown). Thereby, a space (a clearance) is formed between the main body portion 51 of the backlight chassis 50 and the power supply board 60, the tuner board 61, and the inverter board 62; and the power supply board 60, the tuner board 61, and the inverter board 62 are placed predetermined distances away from the main body portion 51 of the backlight chassis 50.

To the power supply board 60 are connected the FPC 64, which is connected to the connection board 35, and an FPC 65, which is connected to the tuner board 61. The power supply board 60 is structured to be detachable/attachable with respect to the FPCs 64 and 65. The tuner board 61 is structured to be detachable/attachable with respect to the FPC 65. The FPC 64 is inserted in an insertion hole 51a provided in the main body portion 51 of the backlight chassis 50, and passes a back surface side of the main body portion 51 to be connected to the connection board 35. The inverter board 62 is, in the same manner as the power supply board 60 and the tuner board 61, connected to an electric wiring (not shown), and is also structured to be detachable/attachable with respect to the electric wiring (not shown). The FPC 65 is an example of “the electric wiring” of the present invention.

According to the present embodiment, the support member 70 is placed at a front side of the main body portion 51 of the backlight chassis 50, the power supply board 60, the tuner board 61, and the inverter board 62. The support member 70 is fixed to the main body portion 51 of the backlight chassis 50 and the square pipe portion 52, and has a function of supporting a reflection sheet 80.

As shown in FIG. 6, the support member 70 includes four side surface portions 71 and a support portion 72, which is fixed to the four side surface portions 71. As shown in FIG. 2, the support portion 72 is placed a predetermined distance away from the main body portion 51 of the backlight chassis 50. As shown in FIG. 6, the support portion 72 is formed lattice-shaped. Thereby, a plurality of opening portions 70a are formed in the support member 70.

According to the present embodiment, the opening portions 70a of the support member 70 are formed large enough for the power supply board 60, the tuner board 61, and the inverter board 62 to pass therethrough.

To the support portion 72, a plurality of holding members 73 are attached. As shown in FIG. 2, each of the holding members 73 includes two lamp holding portions 73a for holding the fluorescent lamp 90 therebetween, and a sheet support portion 73b for preventing the optical sheet 40 from warping due to heat, for example. The holding members 73 may be integrally formed with the support portion 72. The lamp holding portions 73a and the sheet support portion 73b may be formed separately. The lamp holding portions 73a are an example of the “lamp holding member” of the present invention, and the sheet support portion 73b is an example of the “sheet support member” of the present invention.

At a front side of the support portion 72, the reflection sheet 80 is placed. That is, according to the present embodiment, at a back surface side (rear side) of the reflection sheet 80, the main body portion 51 (the backlight chassis 50) is placed, and also, the reflection sheet 80 is placed a predetermined distance away from the power supply board 60, the tuner board 61, and the inverter board 62 (see FIG. 6). And, between the reflection sheet 80 and the main body portion 51 of the backlight chassis 50, the power supply board 60, the tuner board 61, and the inverter board 62 are placed.

As shown in FIG. 6, the reflection sheet 80 includes a flat portion 81, and four side surface portions 82 formed by bending a circumference portion of the flat portion 81. As shown in FIG. 2, the reflection sheet 80 has a function of reflecting light emitted from back surface sides (rear sides) of the plurality of fluorescent lamps 90, to make the light travel frontward. The reflection sheet 80 may be fixed to the side surface portions 71, or may be fixed to the support portion 72.

As shown in FIG. 6, in the flat portion 81 of the reflection sheet 80, there are formed a plurality of insertion holes 81a, in which the holding members 73 are inserted, and a plurality of insertion holes 81b, in which the lamp sockets 62a fixed to the inverter board 62 are inserted.

FIG. 7 is a sectional view for illustrating a method of replacing the power supply board, the tuner board, and the inverter board of the backlight device according to the embodiment shown in FIG. 2. Next, with reference to FIGS. 3 and 7, a description will be given of the method of replacing the power supply board 60, the tuner board 61, and the inverter board 62.

In replacing the power supply board 60, the tuner board 61, and the inverter board 62, the front cabinet 2 is detached from the liquid crystal display device 10 as shown in FIG. 3.

Then, a front side portion of the liquid crystal display device 10 is removed. Specifically, the connection board 35 is detached from the FPC 64, and then the bezel 11, the liquid crystal display panel 12, the frame 30 and the optical sheets 40 of the backlight device 20 are detached.

Next, as shown in FIG. 7, the reflection sheet 80 is detached from the support member 70.

Then, according to the present embodiment, with the support member 70 fixed to the backlight chassis 50, the tuner board 61, for example, is detached from the main body portion 51 of the backlight chassis 50. At this time, the tuner board 61 is detached from the FPC 65, and is passed through the opening portion 70a of the support member 70.

Thereafter, in an order reverse to the above order, a new tuner board 61 is attached. In this way, the tuner board 61 is replaced.

Replacement of the power supply board 60 and the inverter board 62 is also carried out in the same manner.

According to the present embodiment, as described above, by placing the power supply board 60, the tuner board 61, and the inverter board 62 between the reflection sheet 80 and the main body portion 51 of the backlight chassis 50, a distance between the reflection sheet 80 and the main body portion 51 of the backlight chassis 50 can be made longer than in a case, for example, in which the reflection sheet 80 is placed in contact with a surface of the main body portion 51 of the backlight chassis 50. Thereby, a larger clearance (space) can be formed between the reflection sheet 80 and the main body portion 51 of the backlight chassis 50, and this makes it easier for air convection to occur in an air layer between the reflection sheet 80 and the main body portion 51 of the backlight chassis 50. As a result, when the reflection sheet 80 is heated to a high temperature by heat from the fluorescent lamps 90, the heat of the reflection sheet 80 can be easily transferred to the backlight chassis 50, which leads to improved heat dissipating performance.

According to the present embodiment, the placement of the power supply board 60, the tuner board 61, and the inverter board 62 between the reflection sheet 80 and the main body portion 51 of the backlight chassis 50 makes it possible to replace the power supply board 60, the tuner board 61, and the inverter board 62 from a front side of the liquid crystal television receiver 1. This makes it possible to replace the power supply board 60, the tuner board 61, and the inverter board 62 without moving the liquid crystal television receiver 1, even in a case in which the liquid crystal television receiver 1 is placed close to a wall or the like. Accordingly, it is particularly effective to apply the present invention to, for example, a large-size television receiver, which is difficult to move.

According to the present embodiment, by placing the power supply board 60, the tuner board 61, and the inverter board 62 between the reflection sheet 80 and the main body portion 51 of the backlight chassis 50, the power supply board 60, the tuner board 61, and the inverter board 62 can be placed at an inner side (front side) of the backlight chassis 50. This helps prevent adhesion of dust, water, etc. onto the power supply board 60, the tuner board 61, and the inverter board 62.

According to the present embodiment, by placing the power supply board 60, the tuner board 61, and the inverter board 62 the predetermined distance away from the main body portion 51 of the backlight chassis 50, a still larger clearance can be formed between the reflection sheet 80 and the main body portion 51 of the backlight chassis 50, and this makes it easier for air convection to occur in the air layer between the reflection sheet 80 and the main body portion 51 of the backlight chassis 50. Thus, when the reflection sheet 80 is heated to a high temperature by heat from the fluorescent lamps 90, the heat of the reflection sheet 80 can be transferred to the backlight chassis 50 more easily, leads to further improved heat dissipating performance.

According to the present embodiment, by placing the reflection sheet 80 the predetermined distance away from the power supply board 60, the tuner board 61, and the inverter board 62, a still larger clearance can be formed between the reflection sheet 80 and the main body portion 51 of the backlight chassis 50, and this makes it easier for air convection to occur in the air layer between the reflection sheet 80 and the main body portion 51 of the backlight chassis 50.

According to the present embodiment, the power supply board 60, the tuner board 61, and the inverter board 62 are structured to be detachable/attachable with respect to the main body portion 51 of the backlight chassis 50, with the support member 70 attached to the backlight chassis 50. This makes it possible to replace the power supply board 60, the tuner board 61, and the inverter board 62 without detaching the support member 70 from the backlight chassis 50, and thus to improve workability in replacement of the power supply board 60, the tuner board 61, and the inverter board 62.

According to the present embodiment, by forming, in the support member 70, the opening portions 70a for the power supply board 60, the tuner board 61, and the inverter board 62 to pass therethrough, the power supply board 60, the tuner board 61, and the inverter board 62 can be easily replaced without detaching the support member 70 from the backlight chassis 50.

According to the present embodiment, the provision of the support portion 72 in the support member 70, the support portion 72 being placed the predetermined distance away from the power supply board 60, the tuner board 61, and the inverter board 62, makes it easy to increase the distance between the reflection sheet 80 and the power supply board 60, the tuner board 61, and the inverter board 62. Thereby, a still larger clearance can be easily formed between the reflection sheet 80 and the main body portion 51 of the backlight chassis 50.

According to the present embodiment, forming the support portion 72 lattice-shaped makes it easy to form, in the support member 70, the opening portions 70a for the power supply board 60, the tuner board 61, and the inverter board 62 to pass through.

According to the present embodiment, the attachment of the holding members 73 to the support portion 72 of the support member 70, the holding members 73 each including lamp holding portions 73a and a sheet support portion 73b, makes it easier to detach the power supply board 60, the tuner board 61, and the inverter board 62 from the main body portion 51 of the backlight chassis 50, in comparison with a case in which the holding members 73 are directly attached to the main body portion 51 of the backlight chassis 50.

According to the present embodiment, the tuner board 61 is structured such that it is connected to the adjacent power supply board 60 via the FPC 65, and that it is structured to be detachable/attachable with respect to the FPC 65, whereby replacement of the tuner board 61, for example, can be carried out merely by detaching (replacing) the tuner board 61, which leads to improved workability in replacement of the tuner board 61.

The embodiments disclosed herein are to be considered in all respects as illustrative and not restrictive. The scope of the present invention is set out in the appended claims and not in the description of the embodiment hereinabove, and includes any variations and modifications within the sense and scope equivalent to those of the claims.

For example, in the example dealt with in the above embodiment, a display panel, a display device, and a television receiver are applied to a liquid crystal display panel, a liquid crystal display device, and a liquid crystal television receiver, respectively. This, however, is not meant to limit the present invention, and they may be applied to a display panel, a display device, and a television receiver other than a liquid crystal display panel, a liquid crystal display device, and a liquid crystal television receiver, respectively.

In the example dealt with in the above embodiment, the present invention is applied to a direct-type backlight device, but this is not meant to limit the present invention, and the present invention may be applied to an edge-light-type backlight device.

In the above embodiment, as examples of a circuit board to be placed between the reflection sheet and the main body portion of the backlight chassis, a power supply board, a tuner board, and an inverter board are dealt with, but this is not meant to limit the present invention, and a control board, a main board, and the like, other than the power supply board, the tuner board and the inverter board, may be placed between the reflection sheet and the main body portion of the backlight chassis.

In the example dealt with in the above embodiment, a support member is provided to support a reflection sheet, but this is not meant to limit the present invention, and part of a main body portion of a backlight chassis may be bent such that the reflection sheet is fixed to the bent portion. In this case as well, it is possible to place a power supply board, a tuner board and an inverter board etc. between the reflection sheet and an unbent portion of the main body portion of the backlight chassis.

In the example dealt with in the above embodiment, one support member is provided for supporting the reflection sheet, but this is not meant to limit the present invention, and a plurality of support members may be provided.

In the example dealt with in the above embodiment, holding members each including lamp holding portions for holding fluorescent lamps and a sheet support portion for preventing warp of the optical sheet are fitted to the support member, but this is not meant to limit the present invention, and the holding members may be fitted to the main body portion of the backlight chassis.

In the example dealt with in the above embodiment, the support portion of the support member is formed to be lattice-shaped, but this is not meant to limit the present invention, and the support portion of the support member may be formed to have a shape other than the lattice shape.

In the example dealt with in the above embodiment, spacers are placed between the main body portion of the backlight chassis and the power supply board, the tuner board, and the inverter board, but this is not meant to limit the present invention. The power supply board, the tuner board, and the inverter board may be placed, with no spacer, to be in close contact with a surface of the main body portion of the backlight chassis. Also, part of the main body portion of the backlight chassis may be bent, and the power supply board, the tuner board, and the inverter board may be attached to the bent portion, to thereby form a space (clearance) between the main body portion of the backlight chassis and the power supply board, the tuner board, and the inverter board.

In the example dealt with in the above embodiment, a structure is adopted such that the power supply board, the tuner board, and the inverter board are structured to be detachable/attachable (replaceable) from the main body portion of the backlight chassis with the support member fixed to the backlight chassis, but this is not meant to limit the present invention. Instead, a structure may be adopted such that the power supply board, the tuner board, and the inverter board are detached from the main body portion of the backlight chassis after detaching the support member from the backlight chassis.

In the example dealt with in the above embodiment, a liquid crystal television receiver is provided with a front cabinet that covers the front surface side of the liquid crystal display device and a rear cabinet that covers the back surface side of the liquid crystal display device, but this is not meant to limit the present invention. As in a liquid crystal television receiver 1a of a modified example of the present invention shown in FIG. 8, a rear cabinet that covers a back surface side of a liquid crystal display device 10 may be omitted and only a front cabinet 2 that covers a front surface side of a liquid crystal display device 10 may be provided. In a case, as well, in which the present invention is thus applied to the liquid crystal television receiver 1a having no rear cabinet provided at the back surface side of the liquid crystal display device 10, the power supply board, the tuner board, and the inverter board are prevented from being exposed, and adhesion of dust, water, etc. onto the power supply board, the tuner board, and the inverter board is also prevented. Thus, it is particularly effective to apply the present invention to the liquid crystal television receiver 1a having no rear cabinet provided at the back surface side of the liquid crystal display device 10, the liquid crystal television receiver 1a being, for example, a wall-hung television.

With the liquid crystal television receiver 1a shown in FIG. 8, too, like in the above embodiment, replacement of the power supply board, the tuner board, and the inverter board can be carried out without moving the liquid crystal television receiver 1a, and thus, it is particularly effective to use the liquid crystal television receiver 1a as a wall-hung television receiver or as a recessed television receiver that is recessed in a wall or the like.

In the example dealt with in the above embodiment, the FPC 64 is inserted in the insertion hole which is provided in the main body portion of the backlight chassis, to pass the back surface side of the main body portion to be connected to the connection board. However, this is not meant to limit the present invention, and a structure may be adopted such that none of the FPCs (electric wiring) passes the back surface side of the main body portion of the backlight chassis. With this structure, it is possible to prevent the FPCs (electric wiring) from being exposed to the outside even in a case where the present invention is applied to a liquid crystal television receiver without a rear cabinet.

### LIST OF REFERENCE SYMBOLS

1, 1a liquid crystal television receiver (television receiver)

2 front cabinet (cabinet)

3 rear cabinet (cabinet)

4 speaker

10 liquid crystal display device (display device)

12 liquid crystal display panel (display panel)

20 backlight device

40 optical sheet

50 backlight chassis (chassis)

51 main body portion (back surface portion)

60 power supply board (circuit board)

61 tuner board (circuit board)

62 inverter board (circuit board)

64 FPC (electric wiring)

70 support member

70a opening portion

72 support portion

73a lamp holding portion (lamp holding member)

73b sheet support portion (sheet support member)

80 reflection sheet (reflection member)

90 fluorescent lamp

1. A backlight device, comprising:
a fluorescent lamp;
a reflection member that has a function of reflecting light from the fluorescent lamp;
a chassis that includes a back surface portion placed at a back surface side of the reflection member; and
a circuit board that is attached to the back surface portion of the chassis,
wherein
the circuit board is placed between the reflection member and the back surface portion of the chassis.

2. The backlight device of claim 1, wherein
at least part of the circuit board is placed a predetermined distance away from the back surface portion of the chassis.

3. The backlight device of claim 1, wherein
at least part of the reflection member is placed a predetermined distance away from the circuit board.

4. The backlight device of claim 1, further comprising:
a support member that is placed at a front side of the back surface portion of the chassis to support the reflection member.

5. The backlight device of claim 4, wherein
the support member is structured to be attached to the chassis; and
the circuit board is detachable/attachable with respect to the back surface portion of the chassis, with the support member attached to the chassis.

6. The backlight device of claim 5, wherein, in the support member, there is formed an opening portion that allows the circuit board to pass therethrough.

7. The backlight device of claim 6, wherein
the support member includes a support portion that is placed a predetermined distance away from the back surface portion of the chassis to support the reflection member, and the support portion is lattice-shaped.

8. The backlight device of claim 4, further comprising:
an optical sheet that is placed at a front side with respect to the fluorescent lamp; and
a sheet support member that is placed at a rear side of the optical sheet to prevent the optical sheet from being warped, wherein
the support member includes a support portion that is placed a predetermined distance away from the circuit board and supports the reflection member, and the sheet support member is provided in the support portion of the support member.

9. The backlight device of claim 4, further comprising:
a lamp holding member that holds the fluorescent lamp, wherein
the support member includes a support portion that is placed a predetermined distance away from the circuit board and supports the reflection member, and
the lamp holding member is provided in the support portion of the support member.

10. The backlight device of claim 1, wherein
the circuit board is formed with a plurality of circuit boards, and
the circuit boards are connected to an adjacent circuit board of the circuit boards by electric wiring, and detachable/attachable with respect to the electric wiring.

11. The backlight device of claim 1, wherein the circuit board includes at least one of an inverter board, a tuner board, and a power supply board.

12. A display device, comprising:
the backlight device of claim 1; and
a display panel illuminated by the backlight device.

13. A television receiver, comprising:
the display device of claim 12;
a cabinet covering at least part of the display device; and
a speaker.

14. The television receiver of claim 13, wherein the cabinet is not provided at a back surface side of the display device, and the cabinet is structured to cover at least part of a front surface side of the display device.
